(19) United States
(12) Patent Application Publication
(10) Pub. No.: US 2015/0021113 A1
(43) Pub. Date: Jan. 22, 2015

(54) CELLULAR PHONE IGNITION INTERLOCK DEVICE AND METHOD OF CONTROLLING CELLULAR PHONE USAGE

(71) Applicants: Robert Lefevbre, Sudbury (CA); Jason Legault, Sudbury (CA); Patrice Dubreuil, Garson (CA); Jayson Petersen, Seattle, WA (US)

(72) Inventors: Robert Lefevbre, Sudbury (CA); Jason Legault, Sudbury (CA); Patrice Dubreuil, Garson (CA); Jayson Petersen, Seattle, WA (US)

(21) Appl. No.: 13/944,656

(22) Filed: Jul. 17, 2013

(51) Int. Cl. B60K 28/06; H04W 4/00

(52) U.S. Cl. CPC B60K 28/063; H04W 4/008; B60K 2028/003
USPC 180/272

(57) ABSTRACT

A ignition interlock device for a vehicle includes a short-range wireless transceiver (e.g. a Bluetooth® transceiver) configured to receive a wireless signal from a wireless communications device having a short-range wireless transceiver (e.g. another Bluetooth® transceiver). The device includes a microcontroller for generating an ignition control signal and an ignition interlock switch for controlling vehicle ignition in response to the ignition control signal. The device may also inhibit communications using the wireless communications device to ensure safe operation of the vehicle. The device may also send vehicle tracking data to a remote monitoring service (like a fleet manager). The device may also receive remote commands (e.g. from the fleet manager) to disable vehicle functions.

### CROSS-REFERENCE TO RELATED APPLICATIONS

This is the first application filed for the present technology.

### TECHNICAL FIELD

The present technology relates to vehicle ignition interlock devices and to methods of controlling the unsafe use of cell phones or other wireless communications devices by drivers of vehicles.

### BACKGROUND

An estimated twenty-five percent of vehicle accidents can be attributed to the driver's use of a cell phone or other wireless communications device, potentially making a driver up to six times more likely to get in an accident compared to driving while intoxicated.

When driving a vehicle, talking on a cell phone can be distracting, if not fatal. Unlike listening to the radio or conversing with other passengers, operating a cell phone becomes something that must be done quickly to answer a call or hang up a call. Moreover, the very essence of operating a cell phone means that second calls must be identified and accepted or rejected, not to mention volume adjustments, dealing with dropped calls, text messages, and even emails. Some users even use their phones to read the news while driving! In short, use of a cell phone while driving greatly increases the chance for a collision to occur.

Advanced by increasing societal concern, state governments are enacting more and more legislation in an attempt to curtail the use of handheld cellular devices by drivers, both experienced and novice. Several US states and Canadian provinces have prohibited all drivers from using any handheld device while driving (although hands-free devices are permitted). Twenty-eight states have banned handheld device usage by novice drivers and most states are moving to put a complete ban on texting while driving. Although these laws have been put into effect, there is still ambiguity surrounding their enforceability.

For example, some laws cannot be enforced unless a vehicle operator appears to be operating the vehicle in a dangerous manner. A policeman, even if he sees a vehicle operator holding a cell phone to his head, cannot stop the vehicle operator in some jurisdictions if the vehicle operator is not swerving, etc. when observed. Of course, a collision could happen at any time, but the policeman can only cite the vehicle operator if swerving or speeding is occurring, and then the cell phone use can be the basis for a further citation.

Some vehicles have tinted windows that make observing the vehicle operator nearly impossible, so cell phone use while driving cannot be easily monitored. Even the general concept of observing a vehicle operator is dangerous in and of itself, since a policeman cannot maintain safe driving while trying to observe if a cell phone is being held to a vehicle operator's head in a nearby vehicle.

In short, there is a need for a way to ensure that vehicle operators do not operate cell phones while driving. The operation of the cell phone is a frequent cause of collisions. And, while laws have been enacted to combat cell phone use while driving, enforcing those laws becomes difficult for all the reasons enumerated above.

There are several patents that aim at regulating vehicle operator conduct, but none truly meet the need of ensuring that vehicle operators which prevent incoming and outgoing transmissions while driving.

The use of ignition interlock technology is well known, however the use of this technology is generally related to restricting an intoxicated driver from operating a vehicle. For example, U.S. Pat. No. 7,256,700 is for an “Ignition Interlock Device and Method” issued to Ruocco et al. on Aug. 14, 2007. Ruocco et al. is designed to take a sample of a driver's breath, test it to determine the driver's blood alcohol level, and impede vehicle ignition if the blood alcohol level is above a pre-determined threshold. Unlike the present invention, Ruocco et al. impedes vehicle ignition based upon blood alcohol level, whereas the present invention impedes vehicle ignition based on cell phone non-usage.

Similarly, U.S. Pat. No. 4,689,603 is for a “Vehicle Ignition and Alarm System” issued to Conigliaro et al. on Aug. 25, 1987. Conigliaro et al. describes a digital code-controlled ignition and security system for a vehicle, including an alcohol-detector device for preventing ignition when a predetermined alcohol level is detected in the breath of the operator. Unlike the present invention, Conigliaro et al. impedes vehicle ignition if a driver is intoxicated, whereas the present invention impedes vehicle if a secure blue tooth paired cellphone is not present within a certain distance.

Numerous devices offer a potential solution to prevent vehicle cell phone usage, but all known devices at this point attempt to solve the problem in a different fashion. One device is discussed in U.S. Pat. No. 6,978,146, “Device for Blocking Cellular Phone Signals,” issued to Yardman on Dec. 20, 2005. Yardman's is a device for blocking cell phone signals in a vehicle or another predetermined area. Unlike the present invention, Yardman deters cell phone usage in a vehicle by blocking signals, whereas the present invention deters cell phone usage in a vehicle by other means.

Another cell phone usage deterrent is identified in U.S. Pat. No. 7,123,874. This patent is for a “Cellular Phone Blocker” issued to Brennan on Oct. 17, 2006, which details a jamming device that can be retrofitted into the electrical system of a motor vehicle. The jamming device is mounted within a dashboard of a motor vehicle, and transmits radio frequency jamming signals in order to block reception by a cell phone within the vehicle. The jamming signals are transmitted when the ignition switch is on, and the jamming signals cease to issue when the ignition switch is not on. Unlike the present invention, Brennan issues a jamming signal to prevent the use of a cell phone or other wireless device in an automobile, whereas the present invention deters the use of a cell phone or other wireless device in the automobile without the use of a jamming signal.

Another signal inhibitor is discussed in U.S. Publication No. 2002/0102968, which is a device for “Wireless Telecommunications Signal Inhibition” issued to Arend et al. on Aug. 1, 2002. Arend et al. is an apparatus that blocks the use of a cell phone or other wireless device within a vehicle by employing sensors that produce a noise signal. Unlike the present invention, Arend et al. transmits a signal to impede the use of wireless devices in a vehicle, whereas the present invention deters the use of wireless devices in a vehicle by other means.

U.S. Pat. No. 6,771,946 is for “Method of Preventing Cell Phone Use While Vehicle is in Motion” issued to Oyaski on Aug. 3, 2004. Oyaski prevents a driver of a vehicle from using a cell phone while said vehicle is in forward motion or reverse motion, by emitting a signal to block cell phone usage when the motor vehicle is placed in gear. Unlike the present invention, Oyaski is linked to the vehicle transmission, whereas the present invention is linked to the vehicle's ignition. Also, Oyaski emits a signal to block cell phone usage, whereas the present invention does not emit a blocking signal to deter cell phone usage.

U.S. Pat. No. 6,496,703 is for “System for Disabling Wireless Communication Devices” issued to da Silva on Dec. 17, 2002. Da Silva is a method of controlling operational capabilities of wireless communication devices, enabling a user to monitor the identities and disable the operational capabilities of wireless communication devices in a moving zone. Unlike the present invention, da Silva impedes the operation of wireless communications devices in a vehicle, whereas the present invention impedes the usage of a wireless communications device in a vehicle without impeding hands-free operation of other functions of the device.

Despite these various efforts to devise technologies to limit the unsafe or unauthorized operation of a vehicle, there remains a need for an improved technology for limiting usage of a vehicle.

### SUMMARY

As a solution to the above-mentioned problem, the present invention provides a Cellular Phone Ignition Interlock Device (CID) which is also capable of inhibiting incoming and outgoing communications to and from the device. The present invention limits the distractions caused by cellular devices by pairing the cellular phone's internal Bluetooth® transceiver with the Bluetooth®-enabled ignition device in order to prevent the user from using transmission features of the cellular device while the vehicle is in operation. The present invention is designed to restrict the vehicle operator from using his cellular phone while driving. In order to close the vehicle's ignition circuit, the driver's cell phone must have paired with the Bluetooth® ignition device

The present invention will communicate with the vehicle of the driver, and upon pairing the Bluetooth® ignition device with the Bluetooth® transceiver of the cellular phone, will permit the authorized driver to operate the vehicle. Although the system allows multiple designated vehicle operators, the vehicle will disable all cell phones within the vehicle which are within range that have been programmed to be disabled once in the presence of the vehicle.

In case the driver has a faulty cellular phone or loses his cellular telephone, an override button will ensure safe vehicle ignition operation for a limited period of time, e.g. up to 1 hour of use. The system also has the ability to unlock the vehicle doors, lower the windows or control other vehicle functions. The vehicle movement can also be tracked via the GPS features of the cellular telephone in order to monitor movement and destination arrivals. The device also has the ability to disable the vehicle remotely should the operator/owner require the vehicle be stopped, shut down or otherwise rendered unusable.

Accordingly, an inventive aspect of the present invention is a ignition interlock device for a vehicle. The device includes a short-range wireless transceiver configured to receive a wireless signal from a wireless communications device having a short-range wireless transceiver, a microcontroller for generating an ignition control signal, and an ignition interlock switch for controlling vehicle ignition in response to the ignition control signal.

Another inventive aspect of the present invention is a system that includes a vehicle having an electronic ignition system, a wireless communications device having a short-range wireless transceiver and an ignition interlock device connected to the electronic ignition system of the vehicle, the ignition interlock device comprising a short-range wireless transceiver configured to receive a wireless signal from a wireless communications device having a short-range wireless transceiver, a microcontroller for generating an ignition control signal, and an ignition interlock switch for controlling vehicle ignition in response to the ignition control signal.

A further inventive aspect of the present invention is a method that entails steps or acts of wiring an ignition interlock device to an electronic ignition system of a vehicle. The ignition interlock device includes a short-range wireless transceiver configured to receive a wireless signal from a wireless communications device having a short-range wireless transceiver, a microcontroller for generating an ignition control signal, and an ignition interlock switch for controlling vehicle ignition in response to the ignition control signal. The method further includes wirelessly connecting a short-range wireless transceiver of a wireless communications device to the short-range wireless transceiver of the ignition interlock device to enable ignition of the vehicle.

The details and particulars of these aspects of the technology will now be described below, by way of example, with reference to the drawings.

### BRIEF DESCRIPTION OF THE DRAWINGS

Further features and advantages of the present technology will become apparent from the following detailed description, taken in combination with the appended drawings, in which:

FIG. 1 is a schematic depiction of a system in accordance with an embodiment of the present invention;

FIG. 2 is a schematic depiction of an ignition interlock device in accordance with an embodiment of the present invention;

FIG. 2A shows wiring schematics for one specific implementation of the ignition interlock device;

FIG. 2B shows the bottom copper layer of a printed circuit board (PCB) implementation of the ignition interlock device;

FIG. 2C shows the top copper layer of the PCB;

FIG. 2D shows a silkscreen layer of the PCB;

FIG. 2E shows all superimposed layers of the PCB;

FIG. 3 is a schematic depiction of a wireless communications device for pairing with the ignition interlock device;

FIG. 4 depicts the wireless communications device displaying a message indicating that the device has successfully paired with the interlock device; and

FIG. 5 is a flowchart depicting main steps of a method in accordance with an embodiment of the present invention.

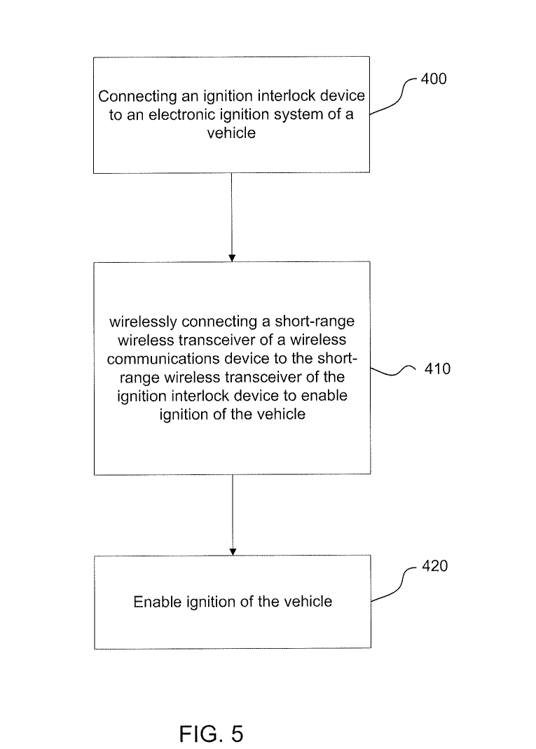

It will be noted that throughout the appended drawings, like features are identified by like reference numerals.

### DETAILED DESCRIPTION

The present invention provides a short-range wireless ignition interlock system that may be implemented using Bluetooth® technology. The system includes a short-range wireless ignition interlock device that may be implemented as a Bluetooth®-enabled interlock device that pairs with a Bluetooth® cellular phone or mobile device as a precondition for starting the vehicle. In other words, the Bluetooth®-enabled cellular phone (or mobile device) must be paired with a Bluetooth®-enabled ignition interlock device that controls ignition of a vehicle such as a car, van, truck, motorcycle, boat, aircraft, etc. Only if the Bluetooth® phone and ignition interlock device are paired can the vehicle be started. In addition, the pairing of the Bluetooth® phone and ignition interlock device may be used to trigger the sending of a signal to the phone to put the phone in a safe-driving mode in which certain functions of the phone are disabled. For example, text messaging (SMS, MMS), e-mail, web browsing, social networking, etc. may be disabled while still permitting hands-free calling. The system may also be used for other functions such as sending tracking data of the vehicle to a fleet manager and receiving remote commands from the fleet manager to disable shut off the vehicle or disable certain vehicle functions. These and other features will be described in greater detail below having regard to the figures.

Device and System

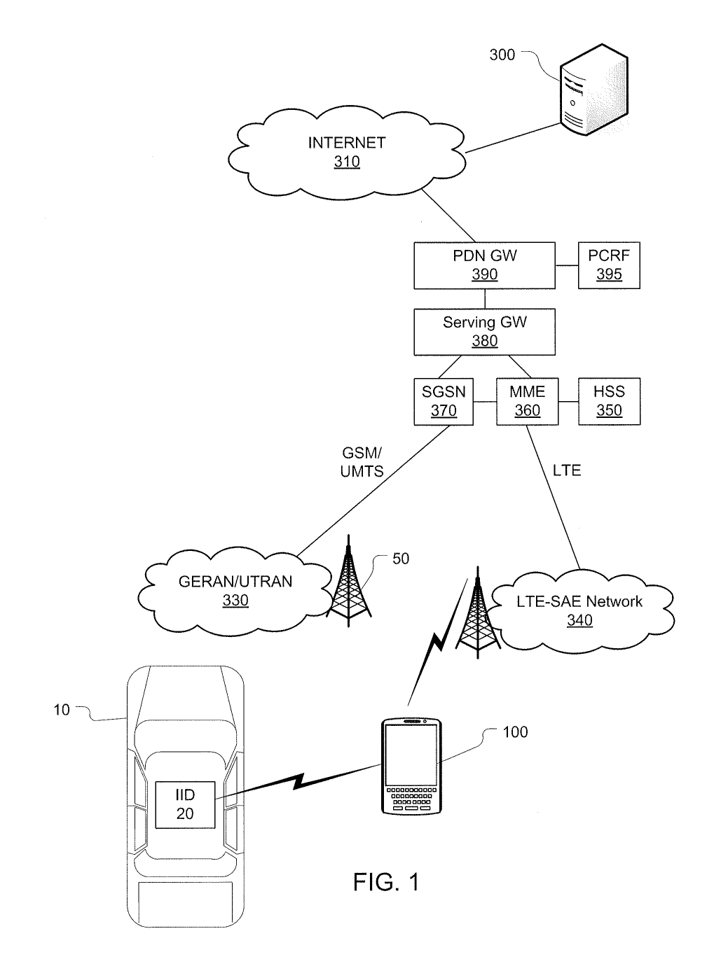

FIG. 1 schematically depicts a system for controlling ignition and subsequent usage of a vehicle 10 in accordance with an embodiment of the present invention. The system includes an ignition interlock device 20 which receives an enabling wireless signal from a wireless communications device 100 such as a cellular phone. When the wireless communications device 100 is not paired with the ignition interlock device 20, the ignition cannot be started and therefore the vehicle cannot be operated. Only when the wireless communications device 100 is paired with the ignition interlock device 20 can the ignition be started.

In addition, the ignition interlock device may collect and transmit tracking data (e.g. location data, speed data, idle time data, etc.) to a vehicle monitoring service or fleet manager 300 which operates a web-based portal or server.

This tracking data may be sent via the Internet 310 using TCP/IP or other such protocols. Data packets may be sent and received by the wireless communications device 100 through a wireless data network represented schematically in FIG. 1 by the GERAN/UTRAN network 330 and the LTE-SAE network 340. A 4G device will communicate via the LTE (Long-Term Evolution—System Architecture Evolution) network whereas a 3G device will access the IP network via GERAN (GSM EDGE Radio Access Network) or UTRAN (Universal Terrestrial Radio Access Network for a UMTS radio access network). LTE data packets are handled by mobile management entity (MME) 360 whereas GSM/UMTS data packets are handled by serving GPRS support node (SGSN) 370. A Home Subscriber Server (HSS) 350, serving gateway 380 and packet data network gateway 390. A Policy Charging and Rules Function (PCRF) 395 provides Quality-of-Service (QoS) information to the packet data network gateway, dynamically manages data sessions, and also determines a charging policy for packets.

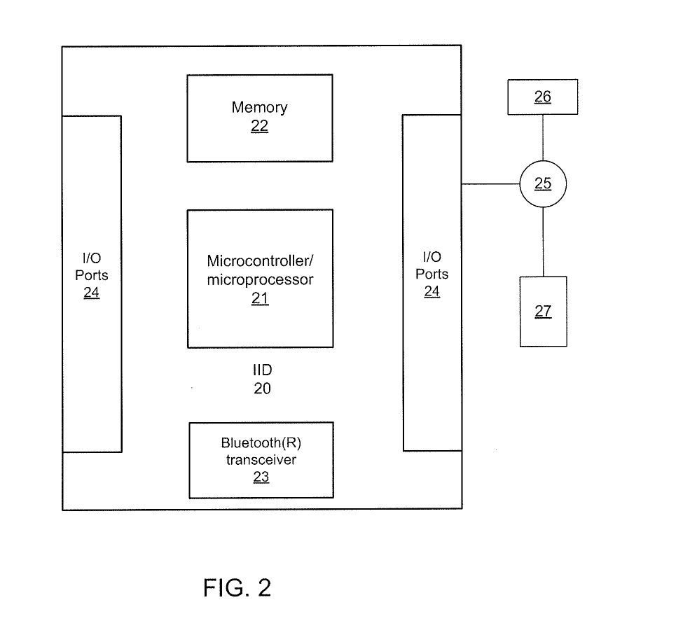

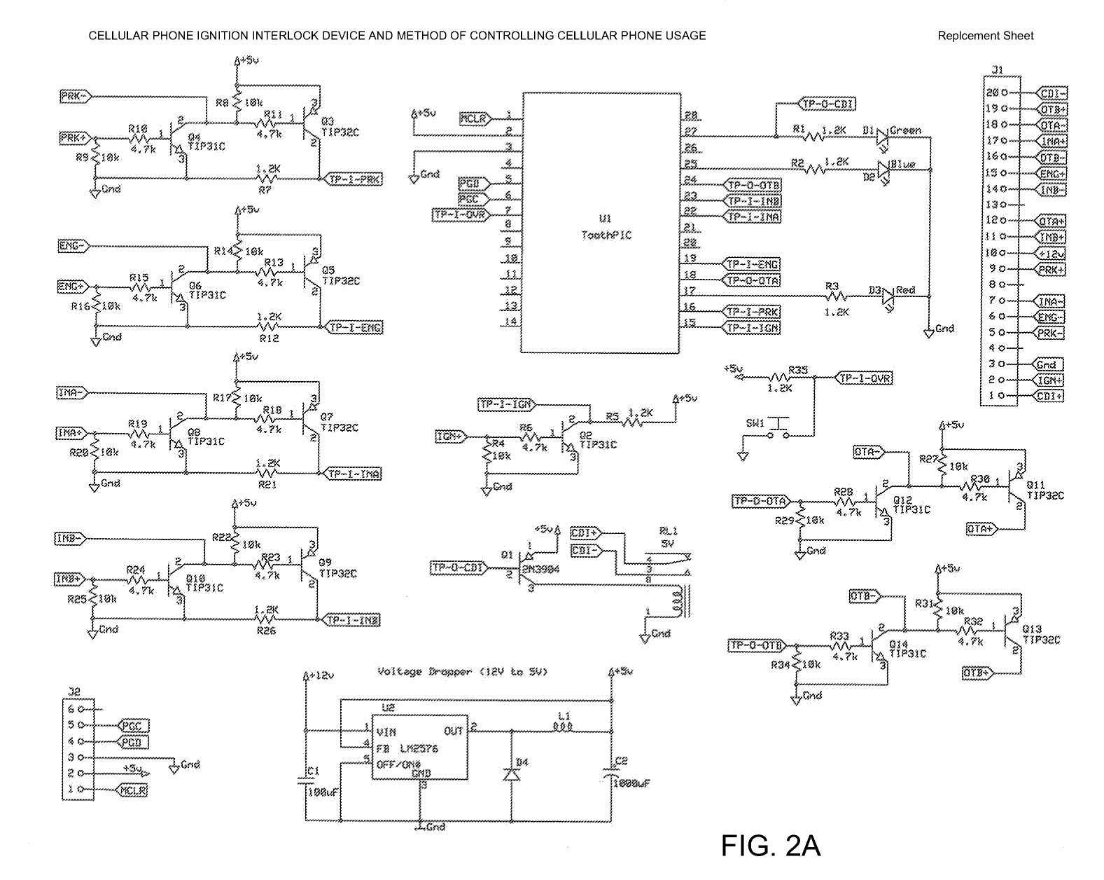

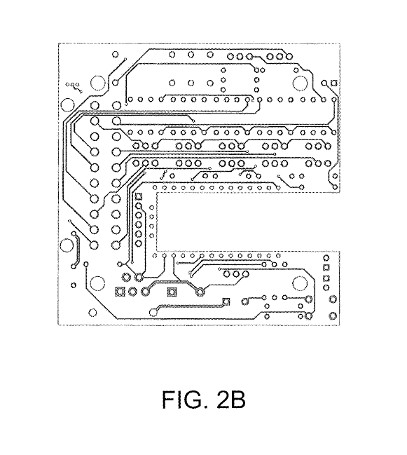

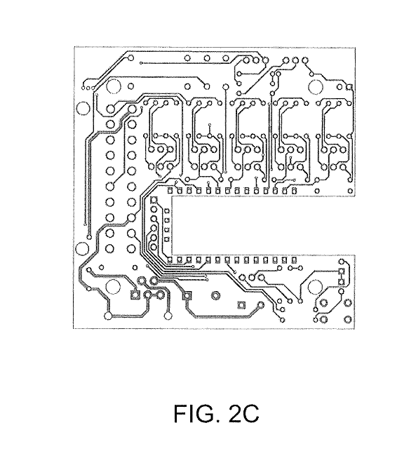

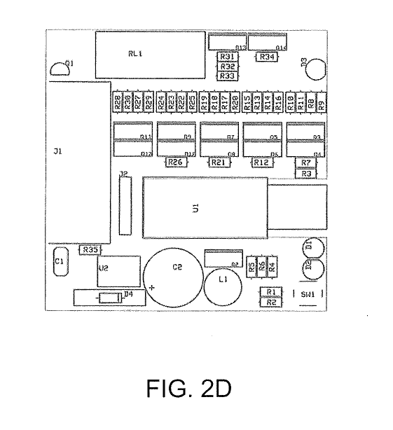

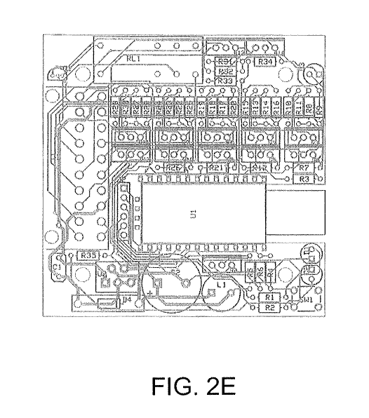

FIG. 2 schematically depicts the ignition interlock device 20. As depicted by way of example in this figure, the ignition interlock device (IID) includes a microcontroller (or microprocessor) 21, a memory 22, a short-range wireless transceiver (e.g. Bluetooth® transceiver 23) and input/output (I/O) ports 24. The Bluetooth® transceiver is configured to receive a wireless signal from a compatible Bluetooth® transceiver of the wireless communications device 100. The microcontroller 21 is configured to generate an ignition control signal in response to detecting a Bluetooth® pairing event between the IID 20 and the wireless communications device 100. The microcontroller 21 sends the ignition control signal to an ignition interlock switch 25 that controls vehicle ignition in response to the ignition control signal. As schematically illustrated by way of example in FIG. 2, the normally open interlock switch 25 closes to permit current to flow from the power supply 26 to the ignition system 27.

FIG. 2A shows wiring schematics for one specific implementation.

FIG. 2B shows the bottom copper layer of a printed circuit board (PCB) implementation of the IID.

FIG. 2C shows the top copper layer of the PCB.

FIG. 2D shows a silkscreen layer of the PCB.

FIG. 2E shows all superimposed layers of the PCB.

With reference to FIGS. 2A-2E, the components are listed below in the following parts list:

| PartID | Description | Manufacturer | Mouser Electronics Part# |
|---|---|---|---|
| R1 | 1.2K Resistor | MF1/4DCT52R1201F | 660-MF1/4DCT52R1201F |
| R2 | 1.2K Resistor | MF1/4DCT52R1201F | 660-MF1/4DCT52R1201F |
| R3 | 1.2K Resistor | MF1/4DCT52R1201F | 660-MF1/4DCT52R1201F |
| R4 | 10K Resistor | MF1/4DCT52A1002F | 660-MF1/4DCT52A1002F |
| R5 | 1.2K Resistor | MF1/4DCT52R1201F | 660-MF1/4DCT52R1201F |
| R6 | 4.7K Resistor | MF1/4DCT52R4701F | 660-MF1/4DCT52R4701F |
| R7 | 1.2K Resistor | MF1/4DCT52R1201F | 660-MF1/4DCT52R1201F |
| R8 | 10K Resistor | MF1/4DCT52A1002F | 660-MF1/4DCT52A1002F |
| R9 | 10K Resistor | MF1/4DCT52A1002F | 660-MF1/4DCT52A1002F |
| R10 | 4.7K Resistor | MF1/4DCT52R4701F | 660-MF1/4DCT52R4701F |
| R11 | 4.7K Resistor | MF1/4DCT52R4701F | 660-MF1/4DCT52R4701F |
| R12 | 1.2K Resistor | MF1/4DCT52R1201F | 660-MF1/4DCT52R1201F |
| R13 | 4.7K Resistor | MF1/4DCT52R4701F | 660-MF1/4DCT52R4701F |
| R14 | 10K Resistor | MF1/4DCT52A1002F | 660-MF1/4DCT52A1002F |
| R15 | 4.7K Resistor | MF1/4DCT52R4701F | 660-MF1/4DCT52R4701F |
| R16 | 10K Resistor | MF1/4DCT52A1002F | 660-MF1/4DCT52A1002F |
| R17 | 10K Resistor | MF1/4DCT52A1002F | 660-MF1/4DCT52A1002F |
| R18 | 4.7K Resistor | MF1/4DCT52R4701F | 660-MF1/4DCT52R4701F |
| R19 | 4.7K Resistor | MF1/4DCT52R4701F | 660-MF1/4DCT52R4701F |
| R20 | 10K Resistor | MF1/4DCT52A1002F | 660-MF1/4DCT52A1002F |
| R21 | 1.2K Resistor | MF1/4DCT52R1201F | 660-MF1/4DCT52R1201F |
| R22 | 10K Resistor | MF1/4DCT52A1002F | 660-MF1/4DCT52A1002F |
| R23 | 4.7K Resistor | MF1/4DCT52R4701F | 660-MF1/4DCT52R4701F |
| R24 | 4.7K Resistor | MF1/4DCT52R4701F | 660-MF1/4DCT52R4701F |
| R25 | 10K Resistor | MF1/4DCT52A1002F | 660-MF1/4DCT52A1002F |
| R26 | 1.2K Resistor | MF1/4DCT52R1201F | 660-MF1/4DCT52R1201F |
| R27 | 10K Resistor | MF1/4DCT52A1002F | 660-MF1/4DCT52A1002F |
| R28 | 4.7K Resistor | MF1/4DCT52R4701F | 660-MF1/4DCT52R4701F |
| R29 | 10K Resistor | MF1/4DCT52A1002F | 660-MF1/4DCT52A1002F |
| R30 | 4.7K Resistor | MF1/4DCT52R4701F | 660-MF1/4DCT52R4701F |
| R31 | 10K Resistor | MF1/4DCT52A1002F | 660-MF1/4DCT52A1002F |
| R32 | 4.7K Resistor | MF1/4DCT52R4701F | 660-MF1/4DCT52R4701F |
| R33 | 4.7K Resistor | MF1/4DCT52R4701F | 660-MF1/4DCT52R4701F |
| R34 | 10K Resistor | MF1/4DCT52A1002F | 660-MF1/4DCT52A1002F |
| R35 | 1.2K Resistor | MF1/4DCT52R1201F | 660-MF1/4DCT52R1201F |
| J1 | 20 pin Molex Connector | 39-30-1200 | 538-39-30-1200 |
| J2 | 6 pin header | 929984-01-06 | 517-929984-01-06 |
| Q1 | 2N3904 | 2N3904 | 610-2N3904 |
| Q2 | TIP31C | TIP31C | 512-TIP31C |
| Q3 | TIP32C | TIP32C | 512-TIP32C |
| Q4 | TIP31C | TIP31C | 512-TIP31C |
| Q5 | TIP32C | TIP32C | 512-TIP32C |
| Q6 | TIP31C | TIP31C | 512-TIP31C |
| Q7 | TIP32C | TIP32C | 512-TIP32C |
| Q8 | TIP31C | TIP31C | 512-TIP31C |
| Q9 | TIP32C | TIP32C | 512-TIP32C |
| Q10 | TIP31C | TIP31C | 512-TIP31C |
| Q11 | TIP32C | TIP32C | 512-TIP32C |
| Q12 | TIP31C | TIP31C | 512-TIP31C |
| Q13 | TIP32C | TIP32C | 512-TIP32C |
| Q14 | TIP31C | TIP31C | 512-TIP31C |
| SW1 | F/W push button | EVQ-PAG04M | 667-EVQ-PAG04M |
| D1 | Green LED | WP7113ZGC/G | 604-WP7113ZGC/G |
| D2 | Blue LED | WP7113QBC/D | 604-WP7113QBC/D |
| D3 | Red LED | WP7113SRC/E | 604-WP7113SRC/E |
| U1 | ToothPick | TP20-SO | 132-TOOTHPICK-2-SO |
| U2 | LM2576 | LM2576T-005G | 863-LM2576T-005G |
| RL1 | 5 V Relay | OMI-SH-205L,594 | 677-OMI-SH-205L |
| C1 | 100 uF Capacitor | FK22Y5V1A107Z | 810-FK22Y5V1A107Z |
| C2 | 1000 uF Capacitor | UHE1H102MHD3 | 647-UHE1H102MHD3 |
| L1 | Power Inductor 100 uH | 13R104C | 580-13R104C |
| D4 | 1N5822 Diode | 1N5822 | 511-1N5822 |

The above parts may be obtained from Mouser Electronics (http://ca.mouser.com/). The ToothPick Bluetooth(R) module may be obtained from RF Solutions (www.rfsolutions.co.uk). For Q1, a central semiconductor should be used to ensure the relay fires.

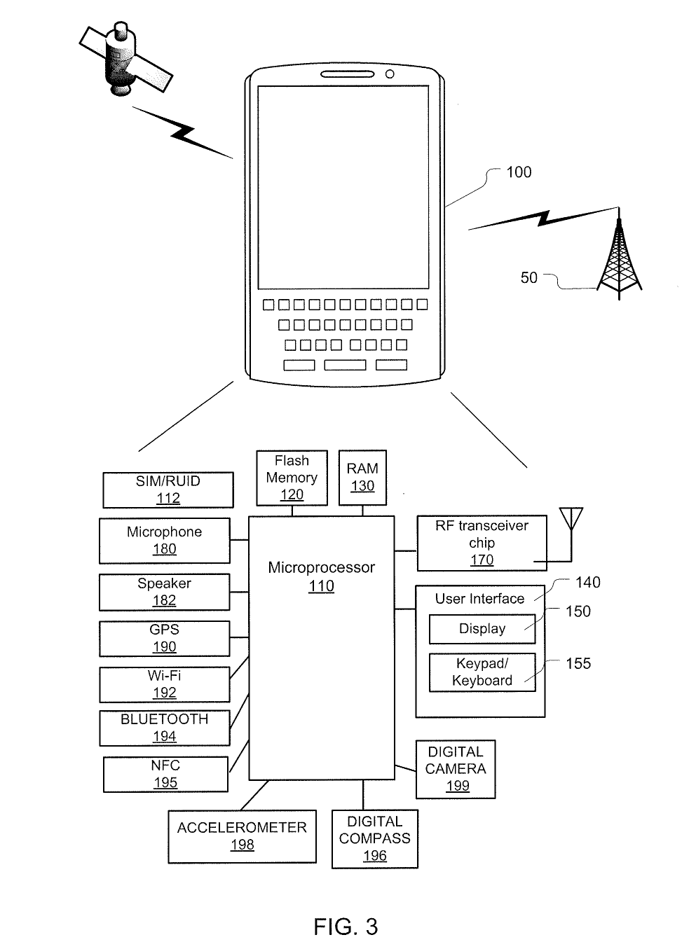

FIG. 3 schematically depicts a wireless communications device 100 (or mobile communications device) that may be used to implement this novel technology. Examples of a wireless communications device include cell phones, smart phones, mobile phones, portable digital assistants, tablets, laptops, notebooks or any other such portable, mobile or handheld electronic communications devices.

As illustrated by way of example in FIG. 3, the mobile device 100 has a processor 110 and a memory 120, 130. The memory of the mobile device 100 may include flash memory 120 and/or random access memory (RAM) 130 although other types or forms of memory may be used. The device may also include expandable memory in the form of a removable microSD memory card.

As depicted by way of example in FIG. 3, the mobile device 100 includes a user interface 140 providing man-machine interface elements for interacting with the mobile device and its applications. The user interface 140 may include one or more input/output devices, such as a display screen 150 (e.g. an LCD or LED screen or touch-sensitive display screen e.g. an Active-Matrix Organic Light-Emitting Diode touchscreen display or equivalent), and a keyboard or keypad 155. A pure touch-screen device may provide a virtual keyboard onscreen and thus need not have a physical keyboard. The user interface may also optionally include any other input devices such as an optical jog pad, thumbwheel, trackball, track pad, etc.

As depicted by way of example in FIG. 3, the mobile device 100 may include a wireless transceiver 170 for communicating with other devices. The transceiver 170 may be a radiofrequency (RF) transceiver for wirelessly communicating with one or more base stations 50 over a cellular wireless network using cellular communication protocols and standards for both voice calls and packet data transfer such as GSM, CDMA, GPRS, EDGE, UMTS, LTE, etc. Where the computing device 100 is a wireless communications device, the device may include a Subscriber Identity Module (SIM) card 112 for GSM-type devices or a Re-Usable Identification Module (RUIM) card for CDMA-type devices. The RF transceiver 170 may include separate voice and data channels. The mobile device 100 may optionally include one or more ports or sockets for wired connections, e.g. USB, HDMI, FireWire (IEEE 1394), etc. or for receiving non-volatile memory cards, e.g. SD (Secure Digital) card, miniSD card or microSD card.

To determine current location, the mobile device 100 includes a position-determining subsystem 190 (e.g. a GNSS receiver such as a GPS receiver) capable of receiving satellite signals from which the current location of the mobile device is calculated.

The position-determining subsystem 190 may be a Global Positioning System (GPS) receiver (e.g. in the form of a chip or chipset) for receiving GPS radio signals transmitted from one or more orbiting GPS satellites. References herein to “GPS” are meant to include Assisted GPS and Aided GPS. Although the present disclosure refers expressly to the “Global Positioning System”, it should be understood that this term and its abbreviation “GPS” are being used expansively to include any global navigation satellite system (GNSS), i.e. any other satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

Another sort of positioning subsystem may be used as well, e.g. a radiolocation subsystem that determines its current location using radiolocation techniques, as will be elaborated below. In other words, the location of the device can be determined using triangulation of signals from in-range base towers, such as used for Wireless E911. Wireless Enhanced 911 services enable a cell phone or other wireless device to be located geographically using radiolocation techniques such as (i) angle of arrival (AOA) which entails locating the caller at the point where signals from two towers intersect; (ii) time difference of arrival (TDOA), which uses multilateration like GPS, except that the networks determine the time difference and therefore the distance from each tower; and (iii) location signature, which uses “fingerprinting” to store and recall patterns (such as multipath) which mobile phone signals exhibit at different locations in each cell. A Wi-Fi™ Positioning System (WPS) may also be used as a positioning subsystem. Radiolocation techniques and/or WPS may also be used in conjunction with GPS in a hybrid positioning system.

Still referring to FIG. 3, the wireless communications device 100 may include a microphone 180, a speaker 182 and/or an earphone jack for voice communications. Optionally, the device may include a speech-recognition subsystem for transforming voice input in the form of sound waves into an electrical signal. The electrical signal is then processed by a speech-recognition module (digital signal processor) to determine voice commands from the voice input.

As shown in FIG. 3, the wireless communications device 100 includes a Bluetooth® transceiver 194. The device may also include other types of short-range wireless transceivers such as a Wi-Fi™ transceiver 192 (e.g. IEEE 802.11 a/b/g/n), and/or a near-field communications (NFC) chip 195. The mobile device 100 may also optionally include a transceiver for WiMax™ (IEEE 802.16), a transceiver for ZigBee® (IEEE 802.15.4-2003 or other wireless personal area networks), an infrared transceiver or an ultra-wideband transceiver.

Optionally, the wireless communications device 100 may include other sensors like a digital compass 196 (magnetometer) and/or a tilt sensor or accelerometer 198. The device may optionally include other sensors such as a proximity sensor, ambient light sensor, and gyroscope. These sensors may also be used by the device to collect tracking data.

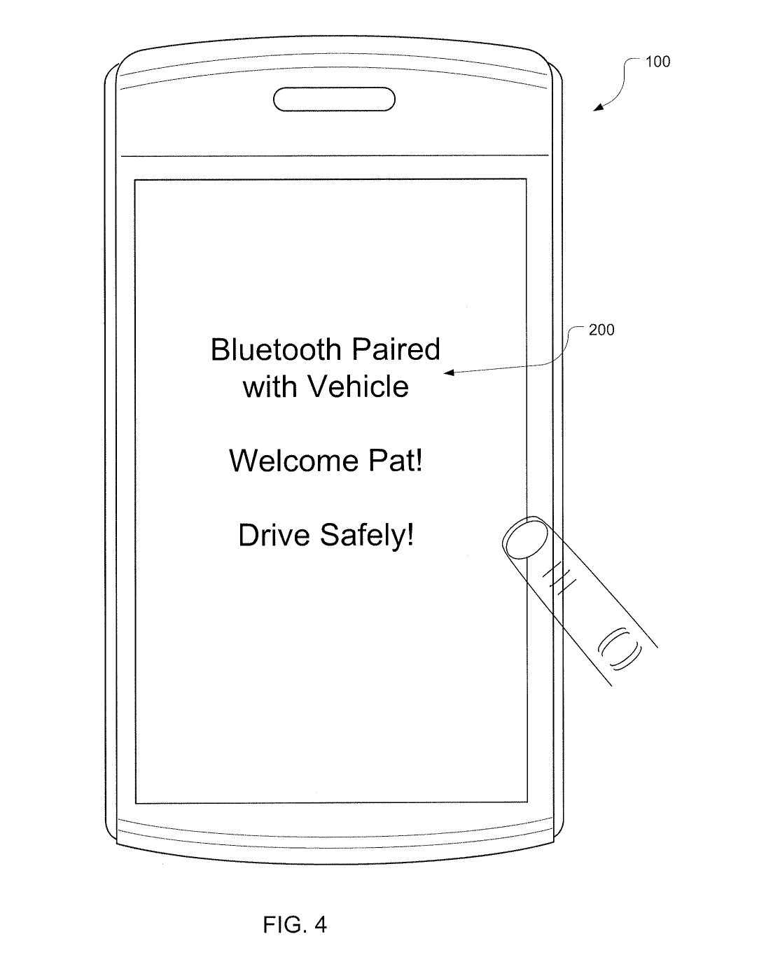

Pairing of the wireless communications device with the ignition interlock device 20 may be done manually or automatically. Once paired, the wireless communications device may display a message 200 or indication that the devices have been successfully paired as shown by way of example in FIG. 4. The user/driver may then start the vehicle and drive the vehicle. Upon interfacing with the Bluetooth(R) signal of the cellular phone 100 with the IID 20, the authorized driver is permitted to operate the vehicle. Although the system allows multiple designated vehicle operators, it only allows cell phones of registered drivers to activate the ignition, thus also serving as a deterrent to vehicle theft and/or also enabling remote unlocking of doors, remote starting, opening of windows, turning on lights, heat, air conditioning, defroster, etc.

In addition, the interlock device may disable certain functions (text messaging, emailing, browsing, etc) of the wireless communications device to ensure that only safe features like hands-free voice telephony remains enabled. The interlock device of the present invention thus helps prevent unsafe cell phone use by the driver of the vehicle.

This technology also enables vehicle tracking and fleet management. For example, a fleet manager may wish to track vehicles, e.g. employee vehicles as they are dispatched to particular jobs. Employees may thus use a single wireless communications device for (i) interacting with a dispatcher service and any interactive web portal for billing, technical support, etc. and (ii) enabling the ignition of their employer's vehicle. Tracking data may be sent from the wireless communications device to provide location data, speed data, gas consumption tracking, mileage, preventative maintenance, idle time data, gas station stops, lunch break stops, etc. By pinging the wireless communications device the fleet manager may retrieve the vehicle's position for monitoring arrival times, service call times, employee downtime, etc. The real-time monitoring enables the fleet manager to determine if services are being delivered in a timely manner. In one embodiment, the interlock device also enables the employee to unlock the vehicle should the keys be locked inside by mistake. The interlock device also doubles as an anti-theft device by preventing unauthorized drivers or individuals to start the vehicle. The fleet manager can also remotely shut down or disable a vehicle if the vehicle has entered a restricted zone or if the employee is terminated.

Depending on the settings, the device may trigger a set of prescribed software scripts that will disable texting, emailing or other data transfer to and from the device while the vehicle's ignition is turned on. This provides for a safer driving environment. The owner or system administrator has the ability to manage each cellular user's level of communication usage. One user may be allowed to use hands-free communication while another has all communication parameters disabled. This ability makes the device ideal for vehicle tracking and fleet management which require constant two-way communication while daily commuters would find the disabling of the communication features a better fit in order to prevent texting while driving.

This technology may also be useful for parents wishing to prevent their children from using cellular devices while they are driving. The instant disabling of the cellular communication upon pairing of the two Bluetooth(R) devices will ensure safe operation of the vehicle being used. Tracking data may also be useful to the parent to monitor the driving style and location of their children.

Preventing unauthorized use of a vehicle will ensure safer operation of the vehicle, as only authorized drivers will be able to drive the particular vehicle. In addition, it will help to prevent vehicle theft and will also improve vehicle retrieval should the vehicle be remotely disabled by the owner of the vehicle (improved recovery). The device also acts as a supervisory tool to help individuals comply with the law and to safely operate a vehicle within applicable regulatory parameters.

Method

Another inventive aspect is a novel method of controlling operation of a vehicle using a wireless-based ignition interlock device. In general, this method entails a step or act of wiring an ignition interlock device to an electronic ignition system of a vehicle. As noted above, the ignition interlock device includes a short-range wireless transceiver configured to receive a wireless signal from a wireless communications device having a compatible short-range wireless transceiver, a microcontroller for generating an ignition control signal, and an ignition interlock switch for controlling vehicle ignition in response to the ignition control signal. The method further entails a step or act of wirelessly connecting a short-range wireless transceiver of a wireless communications device to the short-range wireless transceiver of the ignition interlock device to enable ignition of the vehicle.

In one main implementation of the method, wirelessly connecting the short-range wireless transceiver in the wireless communications device to the short-range wireless transceiver in the ignition interlock device comprises pairing a Bluetooth® transceiver in the wireless communications device with a Bluetooth® transceiver in the ignition interlock device. Although Bluetooth® connectivity is believed to be the best mode of implementing this invention, it will be appreciated that other short-range wireless technologies or communication protocols may be utilized. Other implementations may be possible with other short-range wireless technologies like ZigBee, Wi-Fi or NFC.

In one implementation, the method may further entail generating and sending a signal to the wireless communications device to disable at least one communication function of the wireless communications device. The device may disable communication applications like e-mail or SMS (text messaging), or other applications that are potentially unsafe to use while driving, e.g. web browsing, games, social networking, etc. The device may also disable hardware components like a cellular transceiver or a data channel of a cellular transceiver.

In one implementation, the method may further entail collecting and transmitting vehicle tracking data to a remote monitoring service such as a fleet manager or fleet management center. Data may be location data, speed data, accelerometer data, idle time data, etc. This data enables a fleet manager to analyze the whereabouts of the vehicle, the way the vehicle is being driven, how long the vehicle remains at a location, whether the vehicle is idle too long, etc.

In a related implementation, the method may further entail receiving a remote command and disabling an electronic vehicle subsystem in response to receiving the remote command. For example, a fleet manager may send a command to turn off the ignition of a vehicle. Commands may be manually sent by a human operator at the fleet management center or these commands may be automatically generated and sent in response to a fleet management server detecting a condition (e.g. the vehicle traveling outside of a geofenced area, the vehicle exceeding prescribed mileage, the vehicle traveling above a certain speed, etc.).

In one implementation, the method may further entail receiving an unlock command from the wireless communications device to thereby provide keyless entry. The wireless communications device may pair with the ignition interlock device prior to unlocking the door of the vehicle with a key. The ignition interlock device, upon pairing with the wireless communications device, may further send a signal to a vehicle door lock controller in the vehicle to unlock one or more doors of the vehicle.

In one implementation, the method may further entail recognizing multiple wireless communications devices to thereby provide multiple user access to the vehicle. The interlock device may store a plurality of individual passcodes for each Bluetooth® device to pair with the interlock device. Alternatively, the same passcode may be shared by multiple Bluetooth® devices.

Any of the methods disclosed herein may be implemented in hardware, software, firmware or any combination thereof. Where implemented as software, the method steps, acts or operations may be programmed or coded as computer-readable instructions and recorded electronically, magnetically or optically on a fixed or non-transitory computer-readable medium, computer-readable memory, machine-readable memory or computer program product. In other words, the computer-readable memory or computer-readable medium comprises instructions in code which when loaded into a memory and executed on a processor of a computing device cause the computing device to perform one or more of the foregoing method(s).

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. An ignition interlock device for a vehicle, the device comprising:
a short-range wireless transceiver configured to receive a wireless signal from a wireless communications device having a short-range wireless transceiver;
a microcontroller for generating an ignition control signal; and
an ignition interlock switch for controlling vehicle ignition in response to the ignition control signal.

2. The device as claimed in claim 1 wherein the short-range wireless transceiver is a Bluetooth® transceiver for pairing with a Bluetooth® transceiver in the wireless communications device.

3. The device as claimed in claim 1 wherein the microcontroller generates and sends a signal to the wireless communications device to disable at least one communication function of the wireless communications device.

4. The device as claimed in claim 1 wherein the microcontroller receives a remote command and disables an electronic vehicle subsystem in response to receiving the remote command.

5. The device as claimed in claim 1 wherein microcontroller receives an unlock command from the wireless communications device to thereby provide keyless entry.

6. The device as claimed in claim 1 wherein the microcontroller is configured to recognize multiple wireless communications devices to thereby provide multiple user access to the vehicle.

7. The device as claimed in claim 1 wherein the microcontroller cooperates with the wireless communications device to collect and transmit vehicle tracking data to a remote monitoring service.

8. A system comprising:
a vehicle having an electronic ignition system;
a wireless communications device having a short-range wireless transceiver;
an ignition interlock device connected to the electronic ignition system of the vehicle, the ignition interlock device comprising:
a short-range wireless transceiver configured to receive a wireless signal from a wireless communications device having a short-range wireless transceiver;
a microcontroller for generating an ignition control signal; and
an ignition interlock switch for controlling vehicle ignition in response to the ignition control signal.

9. The system as claimed in claim 8 wherein the short-range wireless transceiver in the ignition interlock device is a Bluetooth® transceiver for pairing with a Bluetooth® transceiver in the wireless communications device.

10. The system as claimed in claim 8 wherein the microcontroller generates and sends a signal to the wireless communications device to disable at least one communication function of the wireless communications device.

11. The system as claimed in claim 8 wherein the microcontroller receives a remote command and disables an electronic vehicle subsystem in response to receiving the remote command.

12. The system as claimed in claim 8 wherein microcontroller receives an unlock command from the wireless communications device to thereby provide keyless entry.

13. The system as claimed in claim 8 wherein the microcontroller is configured to recognize multiple wireless communications devices to thereby provide multiple user access to the vehicle.

14. The system as claimed in claim 8 wherein the microcontroller cooperates with the wireless communications device to collect and transmit vehicle tracking data to a remote monitoring service.

15. A method comprising:
wiring an ignition interlock device to an electronic ignition system of a vehicle, the ignition interlock device comprising:
a short-range wireless transceiver configured to receive a wireless signal from a wireless communications device having a short-range wireless transceiver;
a microcontroller for generating an ignition control signal; and
an ignition interlock switch for controlling vehicle ignition in response to the ignition control signal;
wirelessly connecting a short-range wireless transceiver of a wireless communications device to the short-range wireless transceiver of the ignition interlock device to enable ignition of the vehicle.

16. The method as claimed in claim 15 wherein wirelessly connecting the short-range wireless transceiver in the wireless communications device to the short-range wireless transceiver in the ignition interlock device comprises pairing a Bluetooth® transceiver in the wireless communications device with a Bluetooth® transceiver in the ignition interlock device.

17. The system as claimed in claim 15 further comprising generating and sending a signal to the wireless communications device to disable at least one communication function of the wireless communications device.

18. The method as claimed in claim 15 further comprising receiving a remote command and disabling an electronic vehicle subsystem in response to receiving the remote command.

19. The method as claimed in claim 15 further comprising receiving an unlock command from the wireless communications device to thereby provide keyless entry.

20. The method as claimed in claim 15 further comprising recognizing multiple wireless communications devices to thereby provide multiple user access to the vehicle.

21. The method as claimed in claim 15 further comprising collecting and transmitting vehicle tracking data to a remote monitoring service.
